(19) United States
(12) Patent Application Publication
(10) Pub. No.: US 2012/0190593 A1
(43) Pub. Date: Jul. 26, 2012

(54) PERMEABILITY BLOCKING WITH STIMULI-RESPONSIVE MICROCOMPOSITES

(75) Inventors: David S. Soane, Chestnut Hill, MA (US); Robert P. Mahoney, Newbury, MA (US); Rosa Casado Portilla, Peabody, MA (US); Philip Wuthrich, Lowell, MA (US)

(73) Assignee: Soane Energy, LLC

(21) Appl. No.: 13/359,066

(22) Filed: Jan. 26, 2012

Related U.S. Application Data
(60) Provisional application No. 61/436,373, filed on Jan. 26, 2011.

(51) Int. Cl. C09K 8/035; C09K 8/487

(52) U.S. Cl. 507/111; 507/103; 507/110; 507/114; 507/113; 507/120; 507/124; 507/117; 507/123; 523/130

(57) ABSTRACT

Disclosed is a two-component fluid loss control system comprising a core substrate and a polymeric shell cooperating with each other to form a microcomposite, wherein the core substrate and the polymeric shell are formed from different materials. The system can demonstrate switchable behavior. The core substrate and the polymeric shell can be further modified, where modifications cooperate with each other to form the microcomposite. Also disclosed are formulations for fluid loss control and methods for controlling fluid loss in a well.

### RELATED APPLICATION

This application claims the benefit of U.S. Provisional Application No. 61/436,373 filed Jan. 26, 2011. The entire teachings of the above application are incorporated herein by reference.

### FIELD OF APPLICATION

This application relates generally to fluid loss control additives for oil and gas wells.

### BACKGROUND

To access deposits of oil or natural gas, wells may be drilled into the geological strata where such deposits are likely to be found. Drilling operations may be land-based or sea-based. During drilling, a drilling fluid, also called “drilling mud,” is employed to assist in the drilling process by (1) lubricating the drill bit and cooling it, (2) forming a dense filter cake that encases the wellbore, (3) providing a hydrostatic pressure head that prevents blowout of subterranean fluids under pressure, and (4) allowing transport of the solid material cut out by the drill bit, the “drill cuttings,” back to the surface.

Fluid loss by this filtration mechanism extracts the liquid components from the drilling fluid, leaving a higher level of solids in the remaining drilling fluid composition. The residual solids deposited by fluid loss can be termed “filter cake.” During drilling, for example, leakage of the drilling mud through the permeable walls of the wellbore into the surrounding geologic formation can create excessive wall deposits or filter cake that can accumulate until it physically restricts the drill string. Excess filter cake accumulation can result, for example, in stuck pipes, which can cause costly delays for pipe recovery operations and well cleanout. The increased solids content leads to unplanned changes in the composition, viscosity, rheology, and density of the remaining fluid.

Fluid loss is encountered in other well maintenance operations, including processes such as completion, production, and workover operations. Controlling permeability after perforation, for example, allows well cleanup to prepare for production. Another example pertains to fluid loss during well cementing. During cementing operations, fluid loss can result in leakoff of the cement slurry, compromising the strength or hydraulic sealing properties of the cement job. An effective fluid loss control agent can improve the cement performance as well as reduce the total cost of materials. As other examples, during hydraulic fracturing and sand control treatments, fluid loss control agents can be used to direct the flow of proppants or particulates into the desired channels, rather than allowing them to escape into nontarget zones. As yet another example, fluid loss control (FLC) additives can improve well productivity by avoiding contamination of the productive zones with solids that reduce permeability.

In certain cases, FLC is useful for other well-related operations, such as placement of after gravel packs, during well cleanup, during drilling, for zonal isolation in low permeability regions, for salt and unstable/unconsolidated sands, to prevent collapse of wellbore while drilling permeable zones, for temporary blocking after acidizing, and the like. Prevention of these types of fluid loss can conserve expensive well fluids, such as drilling fluids, completion brines, production, workover fluids, and the like. For example, when a well leaks drilling or completion fluids at high rates (10-1000 bbl/hr) and if the drilling engineers cannot pump in replacement fluid fast enough, lost circulation occurs. Lost circulation is a dangerous condition where wellbore pressure cannot be maintained and the danger of a well blowout exists. Effective fluid loss control can prevent blowouts by avoiding pressure drops and lost circulation.

In certain cases, a temporary FLC effect is needed, where the filter cake can be removed (e.g., with acid or wellbore cleanup chemicals) to restore permeability for production or to clean up the wellbore in preparation for cementing. Some chemical breakers are known to remove filter cake, such as acids, enzymes, and oxidants. These are effective in disrupting filter cakes formed with organic fluid loss control agents like starches, synthetic polymers, and the like. There are disadvantages associated with various filter cake removal agents, however, so that improvements are desirable.

High temperature wells present extra challenges, since most conventional fluid loss control agents lose their effectiveness at well temperatures above 125° C. In some deep wells, the bottom-hole temperature is 150-180° C., or higher. At these temperatures, many of the natural and synthetic polymers used for fluid loss degrade and the byproducts of decomposition can cause formation damage. Sized particulates are also used for fluid loss control, and these have the unintended effect that they can result in permanent blockage of permeability.

There remains a need in the art, therefore, for improved methods to control fluid loss during drilling and completion operations. Desirably, these FLC agents can have reversible properties. There remains a further need in the art for fluid loss control agents that can be used in high temperature wells.

### SUMMARY

Disclosed herein, in embodiments, is a two-component fluid loss control system and methods for the use thereof, wherein the system comprises a core substrate and a polymeric shell cooperating with each other to form a microcomposite, wherein the core substrate and the polymeric shell are formed from different materials. In embodiments, the system demonstrates switchable behavior. The core substrate can comprise a fibrous material or a particulate material. The polymeric shell can comprise a continuous polymer or a discontinuous polymer. The polymeric shell can comprise a hydrogel. The hydrogel can be a polysaccharide selected from the group consisting of guar, carrageenan, alginate, xanthan, hydroxyethylcellulose, hydroxypropylcellulose, plant starch, anionically or cationically modified starch, and carboxymethylcellulose, and carboxymethylstarch, chitosan, and chitosan combined with magnesium oxide (MgO) or other basic material. The hydrogel can also be a synthetic polymer selected from the group consisting of anionic or cationic polyacrylamides, crosslinked anionic or cationic polyacrylamides, polyvinylalcohol, polyethyleneoxide, and polyvinylpyrrolidone. In embodiments, the core substrate and/or the polymeric shell exhibit switchable behavior. The switchable behavior can be triggered by a stimulus selected from the group consisting of a change in temperature, a change in pressure, a change in fluid flow, a change in brine concentration, and a change in the fluid ionic composition. In embodiments, the switchable behavior is reversible. In embodiments, the switchable behavior is a destructive behavior. In embodiments, the destructive behavior is a temperature-induced self-destruction. In embodiments, the core substrate or the polymeric shell exhibits a shape memory behavior. In embodiments, the system further comprises an interpenetrating network formed from the interaction of polymeric shell materials from adjacent microcomposites.

In embodiments, the system comprises at least one of the core substrate and the polymeric shell having been modified with a modification to form a modified component, wherein the modified component forms the microcomposite with the other component. In embodiments, the modification comprises a charged polymer. In embodiments, the modified component cooperates with the other component by charge/charge interactions. In embodiments, each of the core substrate and the polymeric shell is modified with a dissimilar modification, and each of the dissimilar modifications cooperates with the other to form the microcomposite. In embodiments, each of the dissimilar modifications comprises at least one charged polymer, and the dissimilar modifications are oppositely charged. In embodiments, the dissimilar modifications cooperate with each other by charge/charge interactions.

Further disclosed herein, in embodiments, is a formulation for fluid loss control, comprising a fluid loss control additive comprising the fluid loss control system as disclosed above, and a carrier miscible with a well fluid. The well fluid, in embodiments, can be selected from the group consisting of a drilling fluid, a completion brine, a production fluid, a workover fluid, and a cement fluid.

Also disclosed herein, in embodiments, are methods of controlling fluid loss in a well, comprising selecting a core substrate material and a polymer shell material suitable for wellbore conditions in the well, wherein the core substrate material and the polymer shell material are different materials, combining the core substrate material and the polymer shell material to form a system having plurality of cohesive units, formulating the system to produce a formulation that is miscible with a preselected well fluid; and adding the formulation to the well fluid, wherein the well fluid bearing the formulation contacts a zone of fluid loss within the well to reduce fluid loss therefrom. The methods can further comprise adjusting a characteristic within the well to activate a switching property of the formulation. In embodiments, at least one of the core substrate material and the polymer shell material exhibit shape memory behavior.

Additionally disclosed herein are methods of controlling fluid loss in a well, comprising formulating a system of the invention with a carrier miscible with the well fluid to produce a formulation that is miscible with the well fluid; and adding the formulation to the well fluid, wherein the well fluid bearing the formulation contacts a zone of fluid loss within the well and reduces fluid loss therefrom.

### DETAILED DESCRIPTION

Disclosed herein, in embodiments, are systems and methods for controlling fluid loss in well drilling and completion operations, including at elevated temperatures. This is achieved by adding a core/shell microcomposite to the drilling or completion fluid, where the core and shell materials are composed of different materials and where the microcomposite (either core or shell or both) has switchable properties. As used herein, the term “switchable” refers to an ability of a substance to change from one state or set of properties to another state or set of properties in response to a preselected stimulus. In embodiments, when the microcomposite-containing fluid begins to leak out of the wellbore into the surrounding strata, the microcomposite can be deposited as a concentrated layer on the surface of the wellbore, resulting in reduced permeability of the surface. In embodiments, the permeability reduction is reversible (i.e., temporary) since the microcomposite can be removed by a switching mechanism that changes its properties from fluid-blocking to fluid-permeable.

### A. The Core/Shell Microcomposites

As disclosed herein, the microcomposites can comprise two components, a core of structural material (such as fibers or particles) and an outer shell of a switchable polymer, where the core and the outer shell are different materials. As will be described further herein, the shell polymer can be switchable by a change in temperature, by a change in pressure, by a change in the chemical environment, or by other stimuli. In embodiments, the core material can be selected to supply a bridging infrastructure to form a filter cake that blocks the pores of thief zones in the formation, and it can serve as a delivery vehicle for the shell polymer.

In one embodiment, the microcomposite can be formed outside the formation, by adding the shell polymer to the core material or vice versa. In an embodiment, the microcomposite can be fully formed prior to its addition to the formation. The microcomposite can be introduced into the formation by suspending it in a fluid being used within the formation. Alternatively, it can be added to the formation separately from the other well fluids, such as drilling or well maintenance fluids. The microcomposite can be formulated as a powder, as a liquid concentrate suspension, as a gel, or as any other formulation that permits efficient delivery consistent with demands of well drilling or maintenance. In other embodiments, the microcomposite can be formed in situ, by adding a shell polymer into the formation after placement of the core material. The microcomposite can be formulated with a carrier that is suitable for admixing with a well fluid, for example an oil-based well fluid or an aqueous well fluid. In embodiments, the term “well fluid” can include a drilling fluid, a completion brine, a production fluid, a workover fluid, or a cement fluid.

In embodiments, the shell polymer of the microcomposite material cures after placement to form an interpenetrating network of polymers, e.g., associative polymers, that produces a nonporous (or reduced porosity) filter cake. Curing the shell polymer so that the microcomposite material agglomerates in this manner can be accomplished by a switching mechanism, such as by a temperature switching, by ionic interactions, hydrophobic association interactions, entanglement, insolubilization, crosslinking, and the like. Upon curing, the shell polymer can remain attached to the core substrate, but can also form new attachments, or interpenetrating networks, with adjacent core/shell materials and solids, converting individual core/shell particles to a cohesive layer. In embodiments, the amount of shell polymer in the microcomposite is from about 0.01 to about 50% by weight. In other embodiments, the amount of shell polymer in the microcomposite is from about 1 to about 25% by weight.

In embodiments, the microcomposite can have a “shape memory.” As used herein, the term “shape memory” refers to a deformable solid which can be compressed as the filter cake is formed under hydrostatic or mechanical pressure, and then expands or otherwise resumes a previous shape upon release or reduction of the confining pressure. More generally, the shape memory component changes from a temporary deformed shape (e.g., a compressed state) to an original permanent shape (e.g., an expanded state) in response to an external stimulus (e.g., a change in temperature or pressure, the application of light or electricity, exposure to a magnetic field, the introduction of a chemical agent, or the release of an external constraint). Such behaviors can be termed “shape memory behaviors.” In certain embodiments, the shape memory component of the microcomposite is the core substrate. In other embodiments, the shape memory component of the microcomposite is the polymeric shell. In embodiments, the shape memory component of the microcomposite can be pre-compressed during manufacture, having the capacity to expand in the well bore after a period of exposure there to the fluids, temperature, and other wellbore conditions. In other embodiments, the core substrate can be compressed during manufacture and held in a compressed state by the application of a constraining shell polymer. With the alteration of the shell polymer to release its constraining force, the core substrate can expand or assume its initial shape and volume. Shell polymer alteration can occur with the exposure of the shell polymer to various conditions in the wellbore, or with the addition of specific agents intended to weaken its constraining power. The mechanical expansion of the filter cake due to the action of shape memory microcomposites can improve the efficiency of removal of the filter cake, with or without the use of chemical breakers.

In embodiments, the microcomposite component having a shape memory can comprise materials such as fibrous materials with a looped, bent, or coiled structure, or an open cell or closed cell foam material, deformable beads with pockets of entrained gas, or deformable particles or beads of an elastomer. Elastomeric materials can be adapted for use as shape memory components, either in the core substrate or in the polymeric shell.

Crosslinked polymers can be adapted for use as shape memory components. In embodiments, shape memory polymers can be used as shape memory components, for example, linear block copolymers (polyurethanes, polyethylene terephthalate (PET) polypropyleneoxide (PPO) and polyethyleneoxide (PEO) copolymers; polystyrene and poly(1,4-butadiene copolymers; polytetrahydrofuran and poly(2-methyl-2-oxazoline) triblock copolymers; and the like), linear amorphous polynorbornene (Norsorex, CdF Chemie/Nippon Zeon), organic-inorganic hybrid polymers (e.g., polynorbornene units partially substituted by polyhedral oligosilsesquioxane), and the like. In embodiments, crosslinked polymers can be used as shape memory components, for example crosslinked polyurethane, or crosslinked PET-PEO copolymers. Both thermoplastic (e.g., polyether ether ketone (PEEK)) and thermosetting polymers can be used as shape memory components. Polymers capable of shape memory behavior when activated by light can comprise crosslinks formed by photo-crosslinking at a first wavelength of light, with cleavage of the crosslinks at a second wavelength of light. As an example, polymers containing cinnamic groups can exhibit switchable shape memory behavior upon exposure to certain ultraviolet light wavelengths.

The shell polymer of the microcomposite can have a switching mechanism, so that its properties change in response to a stimulus. As an example, the switching behavior of the shell polymer can include the curing process described above, where the shell polymer functions to adhere granules or particles of the microcomposite together. As used herein, then, the term “switching” can include a change in properties from an uncured to a cured state, or from a non-crosslinked to a crosslinked state, or melting or a state of glass transition. Switching also can include a reverse change in properties, as from a crosslinked to a non-crosslinked state or from an adhered to a de-attached state. In an embodiment, the switching behavior includes hydrophobic or hydrophilic association, triggered by a preselected stimulus. A change in the formation chemistry, whether intrinsic or due to extrinsic agents like additives, can act as a trigger for switching behavior. In other embodiments, the switching mechanism of the shell polymer causes swelling of the polymer to form a hydrogel layer that extends into the surrounding fluid. This hydrogel layer can create a localized viscosity effect in the filter cake, increasing resistance to filtration and reducing fluid loss.

The entire microcomposite structure as disclosed herein can be designed with materials that are compatible with the fluid conditions and the targeted well temperature. The microcomposite structure as disclosed herein can also be configured to be temporary or removable after it has set up within the filter cake. Removal of the microcomposites within the filter cake can be accomplished by delayed breaking, acid breaking, enzyme treatment, wellbore cleanout methods (washing, acid, alkali, surfactants), oxidation, hydrolysis, dissolution, by thermal decomposition or other self-destruct mechanisms.

### B. Composition of the Core Substrate

The core substrate of the microcomposite can comprise fibers or particles or any combination thereof, as described below in more detail. Suitable particles can be formed from organic or inorganic materials, or any mixture thereof. Particles suitable for use as described herein can include organic or inorganic particles, or mixtures thereof. A particle can be made from a single substance or can be made from a composite.

In accordance with these systems and methods, inorganic particles for the core substrate can include one or more materials such as barite, calcium carbonate, dolomite, calcium sulfate, kaolin, talc, titanium dioxide, sand, diatomaceous earth, aluminum hydroxide, silica, other metal oxides and the like. Most notable are sand, barium sulfate, gypsum, clay, calcium carbonate, ferric oxide, alumina, boron nitride, lead sulfide, and numerous other naturally occurring and man-made substances. In embodiments, ground calcium carbonate or precipitated calcium carbonate (PCC) can be used as a core substrate particle.

Other examples of inorganic particles include clays such as attapulgite and bentonite. In embodiments, the inorganic compounds can be vitreous materials, such as ceramic particles, glass, fly ash and the like. The particles may be solid or may be partially or completely hollow. For example, glass or ceramic microspheres may be used as particles. Vitreous materials such as glass or ceramic may also be formed as fibers to be used as particles. Cementitious materials may include gypsum, Portland cement, blast furnace cement, alumina cement, silica cement, and the like. Carbonaceous materials may include carbon black, graphite, carbon fibers, carbon microparticles, and carbon nanoparticles.

In embodiments, plastic materials may be used as particles for the core substrate. Both thermoset and thermoplastic resins may be used to form plastic particles. Plastic particles may be shaped as solid bodies, hollow bodies or fibers, or any other suitable shape. Plastic particles can be formed from a variety of polymers. A polymer useful as a plastic particle may be a homopolymer or a copolymer. Copolymers can include block copolymers, graft copolymers, and interpolymers. In embodiments, suitable plastics may include, for example, addition polymers (e.g., polymers of ethylenically unsaturated monomers), polyesters, polyurethanes, aramid resins, acetal resins, formaldehyde resins, and the like.

Addition polymers can include, for example, polyolefins, polystyrene, and vinyl polymers. Polyolefins can include, in embodiments, polymers prepared from C₂-C₁₀ olefin monomers, e.g., ethylene, propylene, butylene, dicyclopentadiene, and the like. In embodiments, poly(vinyl chloride) polymers, acrylonitrile polymers, and the like can be used. In embodiments, useful polymers for the formation of particles may be formed by condensation reaction of a polyhydric compound (e.g., an alkylene glycol, a polyether alcohol, or the like) with one or more polycarboxylic acids. Polyethylene terephthalate is an example of a suitable polyester resin. Polyurethane resins can include, e.g., polyether polyurethanes and polyester polyurethanes. Plastics may also be obtained for these uses from waste plastic, such as post-consumer waste including plastic bags, containers, bottles made of high density polyethylene, polyethylene grocery store bags, and the like. In embodiments, elastomeric materials can be used as particles. Particles of natural or synthetic rubber can be used, for example.

Organic particles for the core substrate can include one or more materials such as starch, modified starch, polymeric spheres (both solid and hollow), and the like. In embodiments, a particle can comprise materials such as lignocellulosic material, cellulosic material, minerals, vitreous material, cementitious material, carbonaceous material, plastics, elastomeric materials, and the like. In embodiments, cellulosic and lignocellulosic materials may include wood materials such as wood flakes, wood fibers, wood waste material, wood powder, lignins, or fibers from woody plants. Organic materials can include various forms of organic waste, including biomass and including particulate matter from post-consumer waste items such as old tires and carpeting materials.

In embodiments, fibers or fibrous materials can be used in the core substrate. Fibers for use as core substrates may be provided in their natural dimensions, or they may be processed to fragment them or otherwise change their shape. Fibers suitable for use as core substrates can be natural, synthetic or artificial (i.e., semisynthetic, made by the manipulation of natural substances like cellulose to form materials not found in nature). Natural fibers can include fibers from animal sources (e.g., wool, hair, silk), fibers from plant sources (e.g., cotton, flax, jute), and fibers from mineral sources (e.g., asbestos, glass). Synthetic and semisynthetic fibers can include fibers made from polyesters, aramids, acrylics, nylons, polyurethane, polyolefin and polyactides. In embodiments, semisynthetic fibers can include fibers made from cellulose substrates, for example cellulose esters (e.g., cellulose acetate), rayon, bamboo fiber, lyocells, viscose rayon, and the like.

In embodiments, the size range of the fibers or particles can have a size ranging from about 0.1 to about 5000 microns, measured along the longest axis. In embodiments, the majority (by weight) of the substrate particles can have a size range of about 1 to about 20 microns, about 2 to about 200 microns, about 10 to about 500 microns, about 100 to about 1000 microns, or about 1000 to about 5000 microns. The particle size of the substrate can be selected to optimize performance for the permeability or the pore size of the targeted well zone. In embodiments, the core substrate can be composed of organic or inorganic materials, from natural or synthetic origin, or combinations thereof.

The substrate material(s) are desirably selected to be compatible with the fluid conditions in the drilling or well maintenance fluids such that, when formulated into a microcomposite, they are capable of blocking the permeability for a preselected or determinable amount of time. In embodiments, materials selected for the core can exhibit switchable behavior. For example, the core materials may be temperature-switchable, but they may also be minimally responsive or unresponsive to temperature changes. In embodiments, the core materials have a certain temperature-switching behavior such that the core materials become more flexible, pliable, or adherent when reaching the desired temperature, for example, the temperature within a well or a formation. In embodiments, the core materials have a switchable behavior whereby they self-destruct under certain conditions. As used herein, the term “self-destruct” refers to complete or incomplete or partial or reversible or irreversible changes in the physical integrity of the material, here a core substrate. Self-destruction can be a switchable behavior, triggered by stimuli such as a change in temperature, a change in pressure, a change in fluid flow, a change in brine concentration, a change in the fluid ionic composition, and the like. For example, a core substrate having temperature-switching self-destructive behavior can weaken, break apart, decompose, or dissolve upon exposure to elevated temperature for an extended period of time. In embodiments, the timeframe of a temperature-induced self-destruction is in the range of about 0.1 to about 1000 days.

In certain cases, the core substrate may display switchable behavior whereby its physical integrity changes in response to a discrete substance that is added to the formation or the fluid or an externally-induced change in well or formation conditions.

In embodiments, the core substrate of the core/shell microcomposite can comprise fibers, as described herein. Suitable fibers for the core substrate can include synthetic fibers such as polyether ether ketone (PEEK), poly ethylene terephthalate (PET), cellulose, cellulose acetate, polyether sulfone, 4,4′-dichlorodiphenyl sulfone (UDEL® Union Carbide), glass fibers, glass reinforced plastic, polylactide, poly(lactic acid), poly(glycolic acid), polyimides, polyethylene, polypropylene, nylon, rayon, polyester and polyacrylates. In embodiments, cellulose fibers can be used, in the form of defibrillated wood pulp. In embodiments, the fibers are derived from natural sources such as cotton, wool, feathers, hemp, bamboo, or from the hulls of rice, corn, soy, cotton seeds, peanuts, and the like. In embodiments, the fibers contain recycled cellulose fibers such as mixed office waste (MOW), old newsprint (ONP), and old corrugated containers (OCC). In embodiments, a sol-gel process can be used to modify the fiber surface to vitrify the fiber. In embodiments, the fibers to be used in the core substrate are caused to dissolve or degrade by exposure to acid, alkali, enzymes, oxidants, brine, or elevated temperatures after they have been used to form the microcomposites, and after the microcomposites have been added to the formation. This destructibility of the core substrate can render the filter cake permeable to fluids when that is desired. In other embodiments, the destructibility of the core substrate can render the filter cake more susceptible to removal.

The following table presents fiber candidates and their glass transition temperatures (T_{G}) and melting temperatures (T_{M}). The fibers for the core substrate can be selected such that the melting temperature is higher than the well temperature that they will encounter.

| Fiber type | Composition | T_{G} (° C.) | T_{M} (° C.) | Other |
|---|---|---|---|---|
| Polyamide | eta-aminocaprolactam | 35-44 | 215 | |
| Polyamide | omega-aminoheptane acid | | 224-233 | |
| Polyamide | 1,4 diaminbutane + adipic acid | −5-82 | 290 | |
| Polyamide | hexandiamine (1,6) + adipic acid | 42 | 255-260 | softens at 220 C. |
| Polyolefine | polypropylene | 5 | 169 | |
| Polyolefine | polyethylene | −70 | 105-138 | |
| Polyester | polyethylene terephthalate | 70-80 | 260 | |
| Polyester | polybutylene terephthalate | 40 | 225 | |
| rayon | cupra-ammonium | | 149 | |
| rayon | saponified acetate | | | loses strength at 100 C. |
| | glass | | | loses strength at 316 C. |
| | cellulose acetate | | | softens at 177 C. |
| resin | acrylic | | | softens at 235 C. |
| polyaramide | PEEK | 143 | 324 | |
| polyaramide | polyimide | 315 | | |

In embodiments, the core substrate of the core/shell microcomposite can comprise particles. In embodiments, suitable particles can comprise organic or inorganic materials, or a combination thereof. In embodiments, particles can be in amorphous, flake, or crystalline form. In embodiments, inorganic particles can include inorganic salts and minerals such as sodium chloride (NaCl), calcium chloride (CaCO₃), bentonite, diatomite, sand, silicates, pozzolan, attapulgite, sepiolite, barite, silicone dioxide (SiO₂), and magnesium oxide (MgO). In embodiments, the core material can comprise acid-reactive materials such as CaCO₃, MgO, CaO, magnesium carbonate (MgCO₃), and the like. In embodiments, the acid-reactive materials can be formulated with latent acids or encapsulated acids, such that the acid-reactive core materials become partially or fully dissolved, or weakened, after some time of exposure to the acids. In embodiments, the inorganic particles are in the form of flakes such as kaolin, phyllosilicates, mica, talc, feldspar. The flake or plate shaped core particles are believed to be able to align in the filter cake such that they effectively block permeability. In embodiments, organic particles include oxalic acid, oxalate salts, and lignin.

In embodiments, the size of the core substrate fibers or particles can be selected so that the substrates or aggregates thereof block the pore throat sizes of a particular well to minimize fluid invasion. Examples of particle size ranges include about 1 to about 20 microns, about 2 to about 200 microns, about 10 to about 500 microns, about 100 to about 1000 microns, and about 1000 to about 5000 microns for extra coarse zones.

### C. Composition of the Polymeric Shell

In embodiments, the polymeric shell of the microcomposite can comprise synthetic or naturally derived organic materials that can be coated onto the core substrates and that have a triggered switching property. The shell polymers can be coated onto or attached to the core substrates as a continuous coating or as regions of coating, or they can be saturated into the substrates. In certain embodiments, the shell polymers remain attached or partially attached to the core material when the microcomposite is placed in a fluid suspension.

In embodiments, the shell polymers hold the substrate particles together once the filter cake has been formed, and then, in response to a change in conditions, the bonding strength of the shell polymers is weakened, allowing the filter cake to break down. This set of behaviors represents a triggered switching behavior. In response to a specific stimulus, or trigger, the shell polymer can exhibit a triggered switching behavior, including behaviors such as softening, tackifying, crosslinking, curing, hardening, entanglement, dissolving, swelling, expansion, shape memory changes, network formation, and the like. The triggering mechanism for the triggered switching behavior of the shell polymer can be based on stimuli that include changing conditions such as temperature, ionic strength, pressure, compression, surface tension, or the like, or exposing the polymer to substances such as polyvalent salts, oxidants, acids, alkali, reducing agents, hydrocarbons, adjacent polymers, adjacent particles, and the like. The triggering mechanism can be an environmental stimulus (e.g., a condition or a substance within the well or the formation), or it can be an externally-imposed stimulus (e.g., a changed condition or added substance attributable to an outside agency such as a human operator or a mechanized delivery system). In embodiments, switching takes place at an identifiable inflection point in a physical property such as temperature (e.g., at a glass transition temperature, a melting temperature, a decomposition temperature, or at another temperature where the triggered switching activity takes place). In other embodiments, switching takes place at an identifiable inflection point in some other property, for example a chemical property (e.g., pH or ionic strength).

In embodiments, shell polymers can comprise one or more hydrophobic/hydrophilic block or graft copolymers. In such copolymers, the hydrophobe can allow the copolymer to stick to the core substrate, while the hydrophile allows spatial “gluing” and “ungluing.” The “gluing” permits attachment of microcomposites (i.e., core substrates bearing polymeric shells) to each other, while “ungluing” allows their detachment. In such an embodiment, the ungluing can be accomplished by ionic strength change (for example, during wellbore cleanout, during perforation and during production flow), by pH induced transition (changing coil dimension), by peroxide induced degradation, by collapsing the polymer structure with divalent/multivalent salt bridges, or by other mechanisms that would be understood by those of ordinary skill.

In embodiments, the shell polymers can comprise biologically derived materials such as starches, hydrophobic starches, high temperature stable starches, hydroxyethylcellulose (HEC), carboxymethylcellulose (CMC), guar, alginate, chitosan, lignosulfonate, and xanthan. In embodiments, the shell polymers can comprise synthetic polymers such as hot-melt adhesives (HMA), pressure-sensitive adhesives (PSA), hydrogels, PEG/PPG copolymers, vinyl polymers, styrene/butadiene resins, AMPS copolymers, and the like. In embodiments, the elevated temperature in the wellbore (>about 50° C.) activates the shell polymer (such as the gelatinization of a starch) and causes the microcomposite materials to agglomerate upon contact. In embodiments, for higher temperature well conditions, the starches can be modified with epichlorohydrin (see, for example, U.S. Pat. No. 5,851,959), POCl₃ (see, for example, U.S. Pat. No. 4,652,384), various hydrophobes, borate, or other crosslinkers and modifiers to retard the decomposition process. In embodiments, the shell polymer further dissolves or degrades over time, allowing the attached microcomposites to be released from their attachments to each other.

In embodiments, the shell polymer can swell or partially dissolve when exposed to the well fluid conditions, forming, for example, a hydrogel for reduced permeability in the filter cake. Examples of polymers that can form hydrogels are hydroxyethylcellulose (HEC), guar, starches, crosslinked polyacrylamides or AMPS/acrylamide copolymers. In the case of borate crosslinked polymers, the hydrogel can be degraded by hydrolysis of the borate ester linkages when the pH is lowered.

In embodiments, the shell polymers can comprise hot melt adhesives (HMA). The HMA polymers can be selected to be tacky at the temperature at which the filter cake will be formed. Examples of suitable HMA polymers for high temperature applications are polyamides, which can be used up to temperatures of about 200° C. Some commercial polyamides are Platamid (for use temperature up to about 135° C.) and Macromelt (for use temperature up to about 190° C.). Other examples of HMAs include styrene block copolymers such as: styrene-butadiene-styrene, styrene-isoprene-styrene, styrene-ethylene/propylene. Commercial names of representative polymers of this kind include Kraton D1155. Other polymers for high temperature applications that can be suitable for these applications are polyolefins such as Technomelt (Henkel), polyesters, and polyurethanes. If HMAs are used as shell polymers for microcomposites as disclosed herein, the filter cake formed thereby can be broken, degraded or changed in its permeability or other properties by modifying the HMA component of the microcomposites. For example, increasing the temperature can further soften certain HMAs, and/or chemicals can be injected to partially soften or dissolve the adhesive once it has formed.

In other embodiments, the core substrate can be coated with associative polymers. As used herein, the term “associative polymer” refers to those polymers that associate with each other forming a weak crosslink between polymer chains when the concentration of polymers in a milieu is sufficiently high. When associative polymers are used as coating polymers for microcomposites as disclosed herein, they can be used for fluid loss control. Not to be bound by theory, it is understood that, as the polymer-coated substrates start to form the filter cake, the concentration of the associative polymers that are localized on the surface of the substrates, increases. The result is that the polymers coating different microcomposites (formed from fibrous or particulate core substrates) will associate with each other adding strength to the filter cake. The interactions among the associative polymers can be reversed by various methods, for example by an increase of temperature or by diluting the concentration of the associative polymers (e.g., by injecting fresh liquid into the formation). Examples of associative polymers suitable for high temperature applications are sulfonated polymers such as Flodrill AN125VLM and Flodrill DP/AS 2089 (SNF, Inc.).

### D. Coating Methods

The shell polymer can be applied to the core substrate by a variety of known methods such as saturation, blending, spray drying, dipping, padding, spraying, or grinding the two components in the presence of each other. In embodiments, the shell polymer can be applied to the core substrate in a continuous inline process, where the shell and core materials are contacted with each other for a sufficient amount of time to form the microcomposite.

In embodiments, one or both of the core substrate and the polymeric shell can be modified with a modification to form a modified component. For example, one or both can be modified with a charged polymer. The interaction or cooperation of the modified components then forms the microcomposite. For example, each component can be modified with an oppositely charged polymer, and the polymers comprising the modified component can interact by charge/charge interactions, thereby binding the core substrate and the polymeric shell together to form the microcomposite. In other embodiments, one or both can be modified with other dissimilar modifications that cooperate with each other to form the microcomposite.

In embodiments, for example, the shell polymer can be attached as grains or domains of polymer on the fibers or particles of the core substrate, using a charge/charge interaction method. In the charge/charge interaction method, core particles (or fibers) can be contacted with oppositely charged shell polymer domains to attach the shell to the core by charge interactions. Multiple coating layers can be used. In other embodiments of the charge/charge interaction method, the core particles or fibers can be modified with a charged polymer that has opposing charge to the shell polymer. After this modification, the anionic core particles/fibers can be contacted with cationic shell polymer (or cationic core particles/fibers are contacted with anionic shell polymer), allowing the core and shell to become attached by charge interactions. In further embodiments, the shell polymer can be modified with one charged polymer and the core material is modified with another charged polymer, having opposing charge. The modified shell and modified core are then allowed to contact each other and self-assemble into an ionically associated microcomposite. The shell polymer of this embodiment may be either dissolved or particulate. In the event that the shell polymer is a particulate, the particle size of the shell polymer is smaller than that of the core material. Shell polymers may be applied to the core substrate as a continuous or discontinuous coating, or as a discontinuous coating that can form itself into a continuous coating. For example, a shell polymer applied initially as granules on the surface of the core substrate can melt to become a continuous coating. Discontinuity of the coating allows the core substrate to come into contact with the microenvironment, so that conditions in the microenvironment can affect the integrity and behavior of the core substrate.

In embodiments, the core substrate can be treated with a first charged polymer in aqueous solution to induce a charge on the surface of the substrate. After treatment with the first charged polymer, a second polymer with opposing charge is added, and the second polymer is attached to the polymer-modified substrate by charge/charge interaction. The second polymer can be a high molecular weight polymer that is water-soluble. The water-soluble polymer becomes attached or anchored onto the polymer-modified substrate.

For example, cellulose fibers comprising the core substrate can be treated with an aqueous solution of a cationic polymer, making cationically modified cellulose fibers. The cationic polymer can be selected from the group consisting of chitosan, poly-diallyldimethyl ammonium chloride, linear or branched polyethylenimine, alkylenepolyamines, polyvinylamine, cationic polyacrylamides, ethylene dichloride/ammonia polymers, poly(styrene/maleic anhydride-imide), epichlorohydrin/dimethylamine polymers, and the like. Separately, a coating polymer, for example a granular or powdered coating polymer having polymer grains such as starch granules, can be treated with an aqueous solution of an anionic polymer to create granules (e.g., starch granules) with an anionic surface charge. For example, a combination of cationic cellulose fibers with anionic starch granules can allow the starch granules to self-assemble onto the surface of the cellulose fibers. These modified cellulose fibers can be processed by heating, curing, crosslinking, partially gelatinizing, to improve the attachment of the starch grains to the fibers. The modified fibers can then be used as the microcomposite, with cellulose fibers as the core substrate and starch granules as the shell polymer.

### E. Temporary Permeability Reduction

In embodiments, the core/shell microcomposite can be designed to create a temporary effect of blocking the permeable surfaces of the well. In such embodiments, the fluid loss control effect can be in place for hours, days, weeks, or months before the effect is reversed. In certain cases, a long-term fluid loss control effect can be in place for years before reversal of the effect. The reversal of the fluid loss control effect can be accomplished by mechanisms such as degradation or dissolution of the core substrate, the shell polymer, or both.

In embodiments, the microcomposite can be formulated with breaker chemicals incorporated into it, such as oxidants, enzymes (for lower temperature wells), acids, latent acids, crosslinkers, and the like. Latent acids suitable for these purposes can include polylactic acid and polyglycolic acid. As an example, the microcomposite formulation can comprise a borate crosslinked polymer or substrate that can be broken by acid treatment. Such breaker chemicals can self-activate to effect the reversal of the fluid loss control effect of the microcomposite formulation. In certain embodiments, the breaker chemical is delivered as a delayed release, or controlled release formulation. In embodiments, the breaker chemical can be delivered separately from the microcomposite. In embodiments, the breaker can be an oxidizer or encapsulated oxidizer that reacts when it comes into contact with methane, natural gas, condensate, or other hydrocarbons in the well. The reaction between the oxidizer and the hydrocarbon creates heat that can help with disintegration of the filter cake.

In other embodiments, the temporary permeability reduction can be caused by a microcomposite with shape memory, as disclosed above. The expansion of the shape memory microcomposite upon reduction in the confining pressure causes the compacted filter cake to become less compacted and more porous for facilitated removal. In embodiments, the shape memory microcomposites are compressed by the hydrostatic pressure or confining pressure of the well fluids as they are pumped into the wellbore. In other embodiments, they are compressed in advance, in the manufacturing process. The manufacturing process for shape memory microcomposites can include mechanical compression of core substrates, then curing with shell polymers before the compression is released. In embodiments, the compressed microcomposites have a time release action, where the shell polymer is allowed to release its binding action on the compressed core particles after some preselected amount of time in the wellbore.

In other embodiments, the temporary permeability reduction can be caused by swellable components of the microcomposite fluid loss control agent. The swelling action can be a delayed response, such that the filter cake remains intact for some preselected period of time, and then it becomes destabilized by the onset of swelling action. Examples of swellable components include highly absorbent or superabsorbent materials, whether they absorb aqueous or nonaqueous fluids. In embodiments, the swellable materials are encapsulated by a protective layer that delays the swelling action. Examples of the swellable materials can include crosslinked poly(acrylic acid), hydrogels, organoclays such as amine modified bentonites, yeasts, silica or silicate based swelling glass materials such as manufactured by ABS Materials (Wooster, Ohio), and other absorbent materials.

In other embodiments, components of the microcomposite are designed with materials such that they will slowly dissolve or degrade in the filter cake, whereupon the filter cake will have more porosity or less physical integrity. The dissolving or degrading mechanism allows the filter cake to retain its permeability reducing effect for some period of time before switching off the fluid blocking effect. The dissolvable or degradable aspects of the microcomposite can be encapsulated with a protective layer to extend the duration of their stability in the wellbore.

### EXAMPLES

### Example 1

### Modification of Fibrous Substrates by Charge/Charge Interaction

Surface-modified peanut shell fibers were made by suspending 10 grams of ground up peanut shells (Golden Peanut, Alpharetta, Ga.) in deionized water in the presence of excess poly(diallyldimethylammonium chloride) (poly-DADMAC or PDAC) (Sigma-Aldrich, St. Louis, Mo.). The peanut shell fiber slurry was then filtered through an 80 mesh screen and the modified fibers were washed with DI water to remove excess polymer.

Cellulose pulp fibers were treated in a similar fashion. Nanofibrillated pulp fiber (EF Tech, Shelton, Conn.) was suspended in water in the presence of excess poly-DADMAC. The fiber slurry was filtered through an 80 mesh screen and excess polymer was washed off with DI water. The modified fibers were then suspended in DI water, at 15% solids.

### Example 2

### Gravimetric Filtration with Modified Fibers

Modified fibers were tested for ability to reduce permeability of water-based mud (WBM) passing through a sand bed. A slurry of mineral fines at 10% solids (mostly Kaolin clay and fine sand) was used as the WBM. Seventy-five grams of the slurry was added to a beaker followed by 5 g of the pulp fibers slurry of Example 1 and 10 g of DI water. In some tests 0.2 g of an anionic liquid flocculant was also added. The two anionic liquid flocculants used in testing were HAF63 and DAF50 commercially available from Polymer Ventures (Charleston, S.C.). Solutions were stirred lightly by hand following addition of flocculant solution.

A Flack Tek (Landrum, S.C.) Speed Mixer “Long Jar” (approx. 6.5 cm D×8.5 cm H) was modified by drilling holes through the bottom and inserting an 80 mesh screen. To the modified jar was added 75 grams of damp −50, +70 mesh sand (Sigma-Aldrich, St. Louis, Mo.). The test mixture was then poured over the sand bed and allowed to drain into a graduated cylinder. Filtrate produced was observed and used to assess different fluid loss control formulations. Specifically, the rate of filtrate production was observed over a three-hour period. If there was minimal fluid loss control produced by the FLC agent, the filtrate passed through rapidly. Progressively greater fluid loss control correlated with slower passage of the filtrate. With maximum fluid loss control, almost no fluid passed through the filter. Results are shown in Table 1 below.

TABLE 1
Gravimetric Filtration Test Results

| FLC Agent | Result |
|---|---|
| Untreated Peanut Shells | − |
| Untreated Pulp Fibers | + |
| PDAC Shells | − |
| PDAC Shells + HAF63 | ++ |
| PDAC Shells + DAF50 | − |
| PDAC Pulp + HAF63 | +++ |
| PDAC Pulp + DAF50 | ++ |

− No fluid loss control observed
+ Minimal fluid loss control observed
++ Moderate fluid loss control observed
+++ Complete fluid loss control observed

Results indicate that certain combinations of fiber modification and anionic liquid flocculants effect greater fluid loss control can be obtained than with unmodified fibers alone.

### Example 3

### Pall Funnel Pressure Filtration Testing Protocol for FLC Agents

In order to demonstrate the ability of the proposed core/shell microcomposite FLC agents in overbalanced drilling and completion scenarios, agents were added to synthetic drilling and completion fluids and filtered under pressure using a pressure filtration funnel (Pall Life Sciences, Port Washington, N.Y.), according to the following protocol. The bottom of the funnel was fitted with a ˜3 micron glass microfiber filter (Whatman GF/D), and a valve was attached to the outlet of the filter. Microcomposite materials comprising a core of precipitated calcium carbonate (PCC) were fabricated, as described in Examples 4-6 below. These materials were tested in a 180 mL formulation at concentrations equivalent to 10 ppb (pounds per barrel). With the outlet valve closed, 200 mL of the mixture were added to the pressure filtration funnel and the top was tightened. A compressed nitrogen source connected to the top of the funnel was used to establish a pressure of 200 psi. The valve at the bottom of the funnel was then opened and the filtrate collected in a 250 mL graduated cylinder. The amount of filtrate after 1 minute, 15 minutes and 30 minutes was recorded.

### Example 4

### Preparation of Surface-modified PCC with Natural Polymers

A modified ARGO® corn starch was prepared by suspending 5 g corn starch in 50 mL deionized water and adding 15 mL of 0.5 wt % aqueous solution of cellulose gum (Aqualon, Wilmington, Del.). After stirring for about 30 min the solution was centrifuged and decanted. The modified starch was then reconstituted in deionized water to a total mass of 55 g. In some experiments, precipitated calcium carbonate was suspended in about 175 mL of deionized water to which was added 5 mL of the modified starch solution. In other experiments, PCC was suspended in about 155 mL of deionized water to which was added 20 mL of a 0.5 wt % chitosan (Chitoclear CG10) solution to modify the PCC surface so that it would have a greater affinity for the modified starch. Then 5 mL of the modified starch solution was added to the slurry. Samples were tested according to the Pall Funnel Pressure Filtration procedure described in Example 3. In some experiments, samples were allowed to incubate at 180 degrees F. for 2 hours following formulation and prior to testing. Others were formulated and tested at ambient room temperature (RT), approximately 70 degrees F. The results of these experiments are set forth in Table 2 below.

TABLE 2

| | | | Filtrate | Filtrate | Filtrate |
|---|---|---|---|---|---|
| | | | @ | @ | @ |
| | | Test | 1 min | 15 min | 30 min |
| Number | Description | Temp | (mL) | (mL) | (mL) |
| A | PCC + Modified Starch | RT | 94 | 180 | 180 |
| B | PCC + Modified Starch | 180 F. | 20 | 80 | 136 |
| C | Chitoclear CG10 PCC + | RT | 40 | 178 | 180 |
| | Modified Starch | | | | |
| D | Chitoclear CG10 PCC + | 180 F. | 22 | 75 | 98 |
| | Modified Starch | | | | |
| E | PCC + Starch | 180 F. | 19 | 76 | 119 |

### Example 5

### Surface-Modified PCC with Latex Polymers

For these experiments, latex polymers were used to surface-modify PCC. The resulting samples of surface-modified PCC were tested according to the protocol of Example 3. The following latex polymers were used: NeoCAR 820, UCAR DL313, UCAR 461, UCAR 3186, and SNAP 720 (available from Arkema (King of Prussia, Pa.); Neocryl A-1052 (available from DSM-NeoResins (Wilmington, Mass.)); Rheotech 4800, a hydrophobically modified alkali swellable emulsion polymer latex polymer available from Coatex (Chester, S.C.). PCC was surface modified with each of these polymers as follows. First, 5 g PCC was suspended in a 100 mL solution of deionized water containing 0.1 g Linear Poly(ethylene imine) 50 (Polymer Chemistry Innovations, Tuscon, Ariz.). After allowing the solution to stir for 1-2 hours, 6 mL of the latex polymer were added and the system was diluted to 180 mL with deionized water. The resulting suspension was allowed to mix for at least 30 min and then tested at ambient temperature using the protocol of Example 3. Results of these experiments are listed in Table 3 below. As a control, when unmodified PCC was tested using the same protocol, there was total fluid loss in about 2 minutes.

TABLE 3

| | | Filtrate @ 1 min | Filtrate @ | Filtrate @ |
|---|---|---|---|---|
| Number | Latex | (mL) | 15 min (mL) | 30 min (mL) |
| A | NeoCAR | 26 | 94 | 114 |
| | 820 | | | |
| B | UCAR | 27 | 84 | 114 |
| | DL313 | | | |
| C | UCAR 461 | 27 | 116 | 167 |
| D | UCAR3186 | 10 | 27 | 36 |
| E | Snap 720 | 25 | 78 | 107 |
| F | Rheotech | 10 | 13 | 16 |
| | 4800 | | | |
| G | Neocryl | 15 | 43 | 59 |
| | A1052 | | | |

### Example 6

### PCC Surface-Modified via Solvent Deposition

This Example demonstrated the viability of modifying the surface of a particle via solvent deposition and the use of that particle for fluid loss control. A small amount of a hydrophobically modified alkali swellable emulsion polymer, Rheotech 4800, was allowed to dry in a vacuum oven at about 50 degrees C. for about 2 days. The dry solids were collected and 1.8 g was dissolved in about 50 g of tetrahydrofuran (THF). To this solution about 15 g PCC was added and the suspension was shaken for about 7 hours. Afterwards the suspension was centrifuged, the supernatant decanted, and the particles allowed to air-dry in a laboratory hood. This modified PCC was then ground with a mortar and pestle to achieve approximately the original particle size before modification. About 5 g of the modified PCC was added to 180 mL deionized water and used in the Pall Funnel Pressure Filtration test as described in Example 3. Results are included in Table 4 below.

TABLE 4

| Filtrate @ 1 min | Filtrate @ | Filtrate | Filtrate Turbidity |
|---|---|---|---|
| (mL) | 15 min (mL) | @30 min (mL) | (NTU) |
| 5 | 11 | 13 | 160 |

### Example 7

### Preparation of Microcomposite for Pressurized Filtration Test

The following materials were used in this Example, and in Examples 8-9

Sized Calcium Carbonate, D₅₀=15-20 micrometers (Tetra Tech, Pasadena, Calif.)

Chitoclear CG10 (Primex, Iceland)

Acetic Acid (Sigma Aldrich, St. Louis, Mo.)

Ammonium Persulfate (Sigma Aldrich, St. Louis, Mo.)

UCAR3186 (Arkema, King of Prussia, Pa.)

Sized calcium carbonate was surface-modified by the following procedure. First, a 0.5 wt % solution of Chitoclear CG10 was formulated in dilute acetic acid. Approximately 12 g of sized calcium carbonate was added to 47.5 g of 0.5 wt % Chitoclear CG10 and stirred for about 30 min. Next, about 2.8 g UCAR3186 was added to the slurry, which was then stirred for an additional 30 min. The coated microcomposite suspension was then ready to be added to a designated fluid in a manner to achieve the desired lb/bbl concentration calcium carbonate.

### Example 8

### Filtration Test of Microcomposite Constituents

Samples were prepared as set forth in Example 7, using water as the designated fluid, and a total volume of 140 mL. In addition to the microcomposite prepared in accordance with Example 7 (Sample 4 in Table 5 below), comparison samples were prepared that eliminated certain components of the Example 7 microcomposite: Sample 1 included only sized calcium carbonate. Sample 2 included only sized calcium carbonate and UCAR3186. Sample 3 included only sized calcium carbonate and Chitoclear CG10. To compare the samples, 140 mL of each was placed in a high-temperature, high-pressure filter press cell (Fann 175 mL model used). In cases where a temperature other than room temperature was used, a 10 minute hold period was allowed for temperature equilibration. The test was then conducted under a 500 psi pressure differential. The results are set forth in Table 5.

TABLE 5

| | % Fluid Loss in | % Fluid Loss in |
|---|---|---|
| Sample | 30 min @70 F. | 30 min @180 F. |
| 1 | 100% | 100% |
| 2 | 100% | 100% |
| 3 | 12.4% | 40% |
| 4 | 11.1% | 23.2% |

### Example 9

### Microcomposite Filter Cake Removal

The experiments in this Example were conducted to demonstrate using a delayed oxidizing agent to destroy the filter cake. A system (140 mL total volume) was prepared using the microcomposite formulation described in Example 7 with NaCl brine at 9.5 lb/gal loading as the designated fluid and guar gum (ICN Biomedicals, Irvine, Calif.) as a suspending agent at a concentration equivalent to 1 lb/bbl loading. Ammonium persulfate (APS) in different concentrations was used as an oxidizing agent. The APS was dissolved in the brine solution immediately prior to combining the brine with the microcomposite formulation. Filtration tests were conducted as described in Example 8, at a temperature of 180 degrees F. In one case the test fluid was incubated at 180 F for 3 hours prior to conducting the filtration test. The results, shown in Table 6, show that low concentrations of APS at elevated temperature can provide a reduction in fluid loss control (i.e. filter cake destruction).

TABLE 6

| | Hold Time | |
|---|---|---|
| APS (g) | (hr) | % Filtrate at 30 min |
| 0 | 0 | 10% |
| 0.1 | 0 | 17% |
| 0.1 | 3 | 45% |
| 2.8 | 0 | 100% |

### Example 10

### Thermal Stability of FLC Agent

The selected FLC agent can be observed under a light microscope. A 50 mL formulation of 10 pounds per barrel (ppb) of the FLC agent in 3% KCl brine can be made. The formulation can then be added to a Parr General Purpose Pressure vessel (Parr Instrument Company, Moline, Ill.) until the chamber is approximately 75% full. The vessel can be closed and placed in a Lab-Line Imperial III radiant heat oven (Lab-Line Instruments Inc., Melrose Park, Ill.) at 170° C. for 24 hours. After heating duration, the vessel can be removed from oven and allowed to cool. Contents can then be removed from the vessel and filtered through an 80 mesh screen. Solids can be observed for visual degradation via light microscopy by comparing images of the FLC agent before and after thermal degradation testing. Observations made can demonstrate the increased temperature resistance of certain FLC formulations in accordance with the present invention, as compared with other FLC treatments in the art.

In a second test, the FLC agent can be used in a gravimetric filtration similar to the method described in Example 2. Identical tests can be run with FLC agents before and after thermal degradation testing. This can demonstrate the ability of formulations in accordance with the present invention to remain intact despite being exposed to high temperature environments. It is expected that other FLC formulations known in the art may have poorer gravimetric results (i.e. high permeability) after being exposed to high temperature.

### Example 11

### Removable Filter Cake and Permeability Restoration

The pressure filtration funnel from Example 3 can be fitted with a 40 micron glass microfiber filter or stainless steel screen. The funnel can be filled with 200 mL 3% KCl brine and brought to a pressure of 200 psi. The valve at the bottom can then be opened and the time required for the funnel to empty is recorded. Then the procedure described in Example 3 can be employed in order to form a filter cake on the filter. At the end of the 30 minute test period the pressure can be relieved and the fluid is removed from the funnel. The funnel can then be loaded with 200 mL of a 1% hydrochloric acid (Sigma-Aldrich, St. Louis, Mo.) solution and pressure is restored to 200 psi with the valve at the bottom of the funnel closed. The valve can be opened and filtrate collected for 30 minute duration. In a final step to establish the extent to which permeability has been returned by the acid wash, 200 mL of 3% KCl solution can once again be loaded into the funnel. The funnel can be brought to a pressure of 200 psi, the valve at the bottom of the funnel is opened and the time required for the funnel to empty can be recorded and compared with the initial value. This procedure can compare certain core/shell microcomposite FLC agents in accordance with the present invention to other agents, including sodium chloride salt particles sized to less than 140 mesh, and calcium carbonate particles sized to less than 140 mesh. The example can demonstrate the reduction in formation damage by the use of formulations in accordance with the present invention, as compared to other formulations in the art.

### Example 12

### Surface Modification of Particles by Associative Polymer and their Use in Fluid Loss Control Formulations

This example describes a proposed method for coating particles with “associative polymers” to produce modified particles suitable for a fluid loss control (FLC) formulations for high temperature applications. It also proposes a mechanism to separate the particles apart after service.

To a 250 ml beaker can be added 50 g of DI-water and 0.5 g of a sulfonated polymer Flodrill DP/AS 2089L (SNF Oil Division, Greeley, Colo.). The mixture can be stirred until all the polymer dissolves. Next 10 g of hydroxyethylcellulose fibers can be added to the solution followed by the slow addition of approximately 100 g of methanol. The addition of the methanol forces the precipitation of the Flodrill polymer onto the fiber surface. The coated fibers can then be isolated by vacuum filtration. These fibers can be used without further purification in a FLC formulation.

As the FLC formulation of this Example is injected in the formation, the fibers can form a filter cake on the pores of the formation. As a result of the creation of the filter cake, the fibers can pack closely together allowing for the coating on the fibers to interact with each other, mainly through hydrophobic interaction. The result would be a strong filter cake.

The filter cake can be removed in the completion steps by the introduction of agents (e.g., cleaning pills) that will contain small amount of non-ionic surfactant (for example a polyoxyethylene stearyl ether). The surfactant will break the hydrophobic interaction of the modified fibers, decreasing the filter cake strength.

### Example 13

### Surface Modification of Particles by Hot Melt Adhesives and their Use in Fluid Loss Control Formulations

This example describes a proposed method for surface-modifying fibers with a hot melt adhesive to produce particles suitable for high temperature-fluid loss control (FLC) formulations. It also proposes a mechanism to separate the particles apart after service in order to disperse the filter cake.

A glass fiber yarn can be coated with a polyamide-based hot-melt adhesive by solution dip-coating. The coating can be done following a continuous process in which the glass yarn is passed through a bath containing a 5 wt % solution of the hot-melt adhesive (for example Platamid 8020 from Arlkema) in cresol. As the glass yarn exits the bath, the solvent can be evaporated and the dry coated sample chopped in a few millimeters length fibers. The obtained fibers can then be used in a FLC formulation.

As the FLC formulation of this Example is injected in the formation, the modified fibers can form a filter cake on the pores of the formation. The high temperature inside the formation can increase the tackiness of the fiber coating, bonding the fibers together, and resulting in a strong filter cake.

The filter cake can be broken when necessary by introducing a breaker chemical into the system, for example, a strong acid that will hydrolyze the amide groups in the fiber coating and weaken the filter cake.

### Example 14

### Exemplary Core Substrates

Defibrillated pulp can be treated with chitosan as an initial component of core substrate, followed by a layer of polyanion (poly-sodium acrylate). Finally, aluminum sulfate can be added to convert the acid groups into insoluble salts, to raise the decomposition point. Later, the filter cake can be re-acidified, so that the salts dissolve. The filter cake can thereby be disrupted.

Another layering agent having a high heat resistance is lignin. An organic solvent can be used to dissolve lignin and deposit it on top of chitosan-coated pulp fibers to make the modified fibers more heat-resistant.

### EQUIVALENTS

While specific embodiments of the subject invention have been discussed, the above specification is illustrative and not restrictive. Many variations of the invention will become apparent to those skilled in the art upon review of this specification. Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth herein are approximations that can vary depending upon the desired properties sought to be obtained by the present invention.

1. A two-component fluid loss control system, comprising:
a core substrate and a polymeric shell cooperating with each other to form a microcomposite,
wherein the core substrate and the polymeric shell are formed from different materials.

2. The system of claim 1, wherein the system demonstrates switchable behavior.

3. The system of claim 1, wherein the core substrate comprises a fibrous material.

4. The system of claim 1, wherein the core substrate comprises a particulate material.

5. The system of claim 1, wherein the core substrate exhibits a switchable behavior.

6. The system of claim 1, wherein the core substrate exhibits a shape memory behavior.

7. The system of claim 1, wherein the polymeric shell comprises a continuous polymer.

8. The system of claim 1, wherein the polymeric shell comprises a discontinuous polymer.

9. The system of claim 1, wherein the polymeric shell comprises a hydrogel polymer.

10. The system of claim 9, wherein the hydrogel polymer is a polysaccharide selected from the group consisting of guar, carrageenan, alginate, xanthan, hydroxyethylcellulose, hydroxypropylcellulose, plant starch, anionically or cationically modified starch, and carboxymethylcellulose, and carboxymethylstarch, chitosan, and chitosan combined with MgO or other basic material.

11. The system of claim 9, wherein the hydrogel polymer is a synthetic polymer selected from the group consisting of anionic or cationic polyacrylamides, crosslinked anionic or cationic polyacrylamides, polyvinylalcohol, polyethyleneoxide, and polyvinylpyrrolidone.

12. The system of claim 1, wherein the polymeric shell exhibits switchable behavior.

13. The system of claim 1, wherein the polymeric shell exhibits a shape memory behavior.

14. The system of claim 2, wherein the switchable behavior is triggered by a stimulus selected from the group consisting of a change in temperature, a change in pressure, a change in fluid flow, a change in brine concentration, and a change in the fluid ionic composition.

15. The system of claim 2, wherein the switchable behavior is reversible.

16. The system of claim 2, wherein the switchable behavior is a destructive behavior.

17. The system of claim 16, wherein the destructive behavior is a temperature-induced self-destruction.

18. The system of claim 1, further comprising an interpenetrating network formed from the interaction of polymeric shell materials from adjacent microcomposites.

19. The system of claim 1, wherein at least one of the core substrate and the polymeric shell are modified with a modification to form a modified component, and wherein the modified component forms the microcomposite with the other component.

20. The system of claim 19, wherein the modification comprises a charged polymer.

21. The system of claim 19, wherein the modified component cooperates with the other component by charge/charge interactions.

22. The system of claim 19, wherein each of the core substrate and the polymeric shell is modified with a dissimilar modification, and wherein each of the dissimilar modifications cooperates with the other to form the microcomposite.

23. The system of claim 22, wherein each of the dissimilar modifications comprises at least one charged polymer, and the dissimilar modifications are oppositely charged.

24. The system of claim 22, wherein the dissimilar modifications cooperate with each other by charge/charge interactions.

25. A formulation for fluid loss control, comprising:
a fluid loss control additive comprising the fluid loss control system of claim 1, and a carrier miscible with a well fluid.

26. The formulation of claim 25, wherein the well fluid is selected from the group consisting of a drilling fluid, a completion brine, a production fluid, a workover fluid, and a cement fluid.

27. A method of controlling fluid loss in a well, comprising:
selecting a core substrate material and a polymer shell material suitable for wellbore conditions in the well, wherein the core substrate material and the polymer shell material are different materials;
combining the core substrate material and the polymer shell material to form a system having plurality of cohesive units;
formulating the system to produce a formulation that is miscible with a preselected well fluid; and
adding the formulation to the well fluid, wherein the well fluid bearing the formulation contacts a zone of fluid loss within the well to reduce fluid loss therefrom.

28. The method of claim 27, further comprising adjusting a characteristic within the well to activate a switching property of the formulation.

29. The method of claim 27, wherein at least one of the core substrate material and the polymer shell material exhibit shape memory behavior.

30. A method of controlling fluid loss in a well, comprising:
formulating the system of claim 1 with a carrier miscible with the well fluid to produce a formulation that is miscible with the well fluid; and
adding the formulation to the well fluid, wherein the well fluid bearing the formulation contacts a zone of fluid loss within the well and reduces fluid loss therefrom.
